(19) United States
(12) Patent Application Publication
(10) Pub. No.: US 2006/0153562 A1
(43) Pub. Date: Jul. 13, 2006

(54) Automatic detection and resolution of fiber cabling errors in optical networks

(75) Inventors: Jean Dolbec, Ottawa (CA); Martin Dubuc, Gatineau (CA); Robert Gaudet, Ottawa (CA); Kirby Koster, Almonte (CA); Douglas James Maclean, Kanata (CA); Aravind Keshav Mistry, Kanata (CA)

Correspondence Address: LAUBSCHER SEVERSON, 1160 SPA RD, SUITE 2B, ANNAPOLIS, MD, 21403, US

(73) Assignee: Meriton Networks inc., Ottawa (CA)

(21) Appl. No.: 10/522,201

(22) PCT Filed: Jul. 23, 2003
(86) PCT No.: PCT/CA03/01111

§ 371 Date: Feb. 16, 2006

Related U.S. Application Data
(60) Provisional application No. 60/398,049, filed on Jul. 24, 2002.

(51) Int. Cl. H04B 10/08

(52) U.S. Cl. 398/20

(57) ABSTRACT

A method of automatically detecting fiber cabling errors in an optical network is described. Fiber connectivity between optical nodes in the network, including initial cabling and any subsequent cabling changes or cabling errors, is detected. The connectivity information including initial link connectivity and changes relating to new fiber connectivity is stored. The invention automatically determines cross-connect and lightpath impact of a cabling change, detects if light paths have been automatically rerouted off affected optical links, and supports operator resolution of cabling problems.

This application claims the benefit of U.S. Provisional Application No. 60/398,049 filed Jul. 24, 2002.

### FIELD OF THE INVENTION

This invention relates to telecommunications systems and more particularly to detection and resolution of cabling errors in optical networks.

### BACKGROUND

Detection of fiber cabling connectivity changes is very difficult within a meshed optical network for service providers offering switched lambda services. Optical switching equipment and their network management systems (NMS) presently do not support automatic detection and display of fiber connectivity changes within meshed optical networks, therefore detection of cabling-error related outages is manual, inconsistent and unreliable.

Automatic and reliable detection of fiber connectivity errors between nodes within optical networks is extremely important in reducing the length of network outages, especially since it is generally agreed by service providers that the majority of optical network outages (often as high as 70%) are not due to external heavy equipment activity (such as road-work), but in fact due to cabling errors by their own technicians at fiber patch panels. These cabling errors include, but are not limited to the wrong cable being unplugged, fibers being plugged into the wrong jack, or fibers plugged into the wrong patch panel.

In view of the complex nature of lightpath architecture and cross-connects, It is often difficult and time consuming to detect when a cabling change has been made in existing meshed optical networks since neither the optical networking equipment or the corresponding NMS can automatically detect a fiber connectivity change between nodes, and distinguish it from a fiber outage.

Existing NMS systems and optical networking equipment typically rely on a manual definition of optical links to define the intended cabling or fiber connectivity between nodes in the network, then rely on external fiber inventory and mapping software packages to document installed fiber connectivity within the network. Determination of fiber cabling errors, then is a manual cross-referencing task for the operator once node hardware or software faults have been ruled out. Essentially once all other root causes have been eliminated then cabling faults become suspect.

The shortcomings of existing solutions are:
1. Outage times are lengthened because all other faults must be ruled out before considering cabling errors.
2. Commissioning of new fibers is lengthened because it is hard to identify errors in connectivity (such as if the cable is accidentally unplugged and re-inserted into a different jack or different fiber patch panel).
3. No automatic detection of initial or subsequent lambda-level fiber connectivity between nodes is available, and therefore there is no visibility of where the fiber has been re-cabled to.
4. Operators have visibility only to the fact that one end of a fiber link is experiencing a loss of light but no easy way to determine if the loss of light is due to a cabling error, a network outage, or cable break.
5. Maintenance windows need to be longer just to manually verify that no cabling errors were made during maintenance activities such as cable upgrades.

In the example shown in FIG. 1 network Node 1 has a fiber patch panel (FPP#1) while Node 2 has FPP#2 and FPP#3. Node 3 has FPP#4 and Node 4 has FPP#5 and FPP#6.

In the fiber cabling change shown in FIG. 1, an existing NMS would only detect the failure of fiber connectivity between A and B, and the fiber link A-C would not be known by the NMS. Until fiber link A-C is manually defined, the new connectivity between Node 1 and Node 2 will not be known or shown by the NMS. To even determine the new connectivity exists, the technical staff would need to manually determine where the fiber is now connected between FPP#1 and FPP#2.

### SUMMARY OF THE INVENTION

This invention proposes a method to automatically detect and direct operator resolution of fiber cabling errors.

The problem solved by the present invention is that optical equipment and/or their NMS cannot automatically detect fiber connectivity changes and cabling errors within an optical network. The invention provides automatic fiber link detection, automatic detection of fiber cabling connectivity changes, updated data to display fiber cabling changes or errors graphically, and also provides data to direct operator resolution of the cabling changes or errors.

Therefore, in accordance with a particular aspect of the present invention there is provided a method of automatically detecting fiber cabling errors in an optical network comprising: detecting initial fiber connectivity between optical nodes in the network; storing information regarding the initial fiber link connectivity; detecting any cabling changes; and determining the impact of the cabling changes on service through the network.

In accordance with a further aspect of the invention there is provided a system for automatically detecting fiber cabling errors in an optical network comprising an automatic optical link detection module to detect connectivity between optical nodes in the optical network; an automatic cabling change detection module for storing initial fiber link connectivity and detecting any cabling changes; and a cabling change impact and resolution module for determining impact of any cabling change.

### BRIEF DESCRIPTION OF THE DRAWINGS

The invention will now be described in greater detail with, reference to the attached drawings wherein:

FIG. 1 illustrates a simple fiber cable change;

FIG. 2 illustrates an example implementation of software components;

FIG. 3 illustrates a complex fiber cable change;

FIG. 4 illustrates a NMS GUI window showing miscabling correlation;

FIG. 5 illustrates a NMS GUI window identifying cross-connects impacted; and

FIG. 6 illustrates a NMS GUI window identifying light paths impacted.

### DETAILED DESCRIPTION OF THE INVENTION

The invention, as will now be described in greater detail provides apparatus and methods of automatically detecting cable routing in a mesh optical network. The apparatus, involving dedicated software allows an operator to view, graphically connections as they exist prior to any changes being made. Typically the operator is provided with a graphical user interface such as a lap top computer which allows the operator to connect to the NMS and download and control connection activity. In one embodiment the connection data is stored in memory at the NMS while it is to be understood that certain data can be stored at network elements.

According to the invention, an operator or technician is shown the impact of any changes being made and given an opportunity to accept or reject the changes if the changes might have negative affects on the network. The operator is prompted, through the GUI to accept all changes before they are implemented

The invention utilizes a three part solution including:
1. Automatic Optical Link Detection (AOLD)—The invention automatically detects fiber connectivity between optical equipment nodes, including initial or existing cabling and any subsequent cabling changes or cabling errors.
2. Automatic Cabling Change Detection (ACCD)—The invention automatically stores initial fiber link connectivity between nodes, and detects cabling changes when new fiber connectivity is detected.
3. Cabling Change Impact and Resolution Support (CCIR)—The invention automatically determines cross-connect and lightpath impacts of a cabling change, detects if lightpaths have been automatically rerouted off affected optical links, and supports directed operator resolution of cabling problems.

Implementation of the invention can vary including any of the following:
1. a consolidated implementation combining all three parts of the solution within an EMS, NMS, or OSS system
2. a consolidated implementation within optical network node software,
3. a distributed implementation across both optical network equipment software and management or third party software systems.

Regardless of where the three software components of this invention are implemented (node software, or management system software), the end result is that operators will have a solution that allows automatic detection of new optical network connectivity, automatic detection of optical cabling changes between optical network equipment, automatic service impact determination, and directed operator resolution of fiber cabling changes or errors.

This invention offers the following unique functionality:
Automatic root-cause analysis of cabling changes in optical networks
Automatic service impact analysis of cabling changes:
Directed operator resolution to ensure consistent impact awareness prior to deletion of optical links

Fiber cabling or connectivity changes can be intentional or the result of cabling errors by technical personnel. Operator errors resulting in a wrong fiber being deleted will be almost eliminated using this invention, since operators can be forced to execute a multi-step process to accept new cabling and delete original fibers. The invention provides information for the operator to identify all services impacted resulting from acceptance of the new fiber connectivity, and supports directed operator resolution implementations. Directed operator resolution force the operator to acknowledge and disconnect all the affected services first, before the original fiber link can be deleted from the network map on the NMS.

A multi-step cabling change/error resolution process as supported by this invention significantly reduces the chance of unintentional or erroneous deletion of a wrong fiber from a management system, and ensures that the complete operational impact of the cabling change is clear to the operator before accepting the change.

The invention utilizes software written to implement the following three functional modules:
1. Automatic Optical Link Detection (AOLD) Module—The AOLD module automatically detects fiber connectivity between optical equipment nodes, including initial cabling and any subsequent cabling changes or cabling errors.
2. Automatic Cabling Change Detection (ACCD) Module—The ACCD module automatically stores initial fiber link connectivity between nodes, and detects cabling changes when new fiber connectivity is detected.
3. Cabling Change Impact and Resolution (CCIR) Module—The CCIR module automatically determines cross-connect and lightpath impacts of a cabling change, detects if lightpaths have been automatically rerouted off affected optical links, and supports directed operator resolution of cabling problems.

Implementation of the invention can be a consolidated implementation combining all three modules (AOLD, ACCD, and CCIR) within an EMS, NMS, or OSS system, consolidated within optical network node software, or the three-part solution can be distributed across optical network equipment software and management software.

The Automatic Optical Link Detection (AOLD) module can be written as a component of the optical equipment's node software as in the following example implementation, or could be implemented in software within an EMS, NMS or OSS system or sub-component. Ultimately the output of the AOLD module would typically be made available to an application, and GUI on an EMS, NMS, third party software package, or OSS system.

The Automatic Cabling Change Detection (ACCD) module can be written as a component of centralized NMS software, as in the following example implementation, or could be implemented in software within optical equipment or node software, EMS, or OSS system or sub-component. Ultimately the output of the ACCD module would typically be made available to an application and GUI on an EMS, NMS, third party software package, or OSS system.

The Cabling Change Impact and Resolution (CCIR) module can be written as a component of centralized NMS software, as in the following example implementation, or could be implemented in software within optical equipment or node software, EMS, or OSS system or subcomponent. Ultimately the output of the ACCD module would typically be made available to an application and GUI on an EMS, NMS, third party software package, or OSS system.

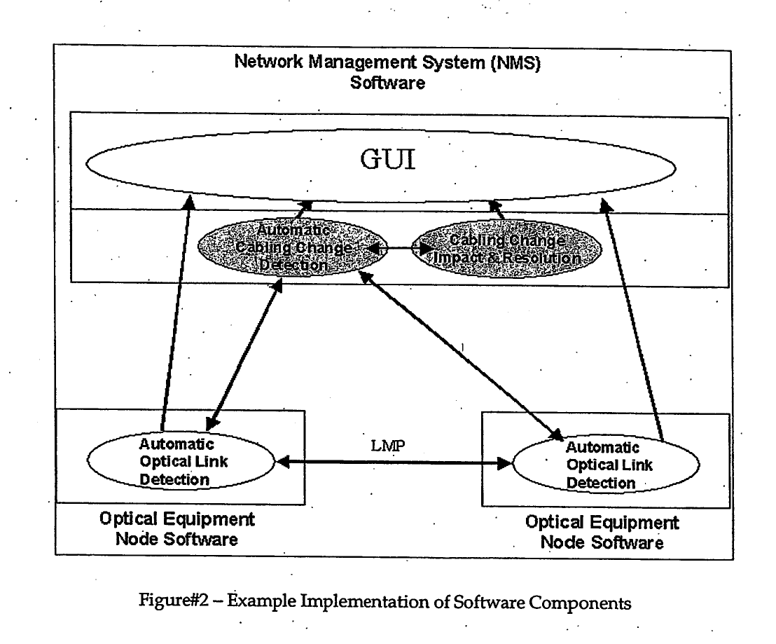

The following example is intended to show one potential implementation of the invention. As previously explained other implementations of this invention are possible. The example implementation as outlined in FIG. 2 is implemented as follows:
The AOLD module is implemented using LMP and is part of the optical equipment's node software
New optical connectivity is automatically displayed on the NMS GUI
The ACCD module is implemented as a component of the NMS software
Optical connectivity changes are automatically displayed on the NMS GUI
The CCIR module is implemented as a component of the NMS software
Impact of accepting connectivity changes is visible to the operator via the NMS GUI
Resolution of the cabling changes is implemented via a Cable Change Resolution Utility on the NMS
Deletion of old fiber connectivity and disconnection of affected services is automated via the NMS GUI

This implementation of an ‘Automatic Optical Link Detection (AOLD)’ module uses a Link Management Protocol (LMP) to automatically detect initial optical link connectivity, as well as automatically detecting new optical link connectivity resulting from cabling moves or miscabling. In this case the LMP software is implemented as part of the optical equipment (or node) software.

This implementation of an ‘Automatic Cabling Change Detection (ACCD)’ module (as shown in FIG. 2) is a centralized NMS based module which automatically stores data for newly detected fiber links and automatically detects cabling changes. The ACCD module also supplies cabling change updates to support visualization of cabling problems on the NMS graphical user interface (GUI).

This implementation of a ‘Cabling Change Impact and Resolution (CCIR)’ module is a centralized NMS-based module which automatically determines service impact of cabling changes, supplies data to visualize cross-connect and lightpath impacts on the NMS graphical user interface (GUI), and supplies data to direct operator resolution of cabling problems via the NMS GUI.

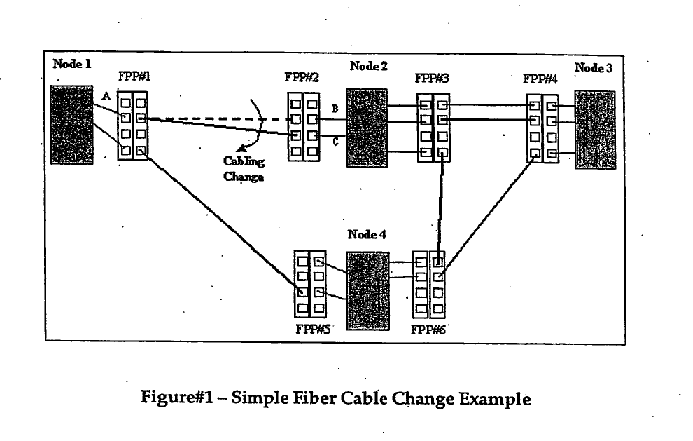

In this implementation, the invention supports a representation of both the original fiber connectivity between nodes and the newly detected fiber connectivity between nodes. Referring to the fiber change example shown in FIG. 1, the AOLD module would work within nodes 1 and 2 to automatically detect that connectivity is lost between A and B, and automatically discover the new connectivity between A and C. The ACCD module would then automatically determine that fiber endpoint A is common to the original fiber A-B, and the new fiber connectivity A-C. Information would then be supplied to the NMS by the ACCD module, and the status of fiber A-B would be changed to ‘miscabled’. The associated EMS, NMS, or OSS would be provided with updated status information on the original fiber link, and any newly discovered fiber links, including those links with common endpoints to the original fiber links.

Since the AOLD and ACCD modules provide complete status information on both the original optical connectivity and the newly discovered optical connectivity, the corresponding EMS, NMS, or OSS can graphically display the information provided. The system(s) providing graphical representation of the fiber connectivity could then for example, be updated by both the AOLD and ACCD modules to graphically display the original fiber link as down, and the new fiber could be displayed as suspect until the original cable is deleted or restored (depending on whether the cabling change was intentional or accidental).

In this implementation, the CCIR module provides automatic impact analysis data, and supports operator directed resolution of the cable change or miscabling situation. The operator utilizes ‘Resolve Miscabling’ functionality offered via a GUI window in the NMS. The CCIR clearly identifies which services are impacted through acceptance of the new fiber connectivity, and forces the operator to disconnect all the affected services first, before the original fiber link can be deleted. The NMS GUI enforces a multi-step operator process, which significantly reduces the chance of unintentional or erroneous deletion of a wrong fiber by an operator, and ensures that the complete operational impact of the cabling change is clear to the operator before executing or accepting the change in cabling.

In this implementation, the node software in the optical network nodes utilizes a point-to-point Link Management Protocol, which automatically detects lambda-level connectivity between adjacent optical network nodes.

To automatically detect new lambda-level connectivity between nodes:
Each node sends a unique data pattern out each non-cross connected lambda, which are UP or receiving light.
Adjacent nodes listen for the data patterns and confirm which lambda they received the pattern on via OSC control plane messages back to the originating node.
Both adjacent nodes acknowledge data connectivity over the associated lambdas.
The NMS is notified of new lambda-level connectivity between nodes.

To automatically detect changes in lambda-level connectivity between nodes for all connected or unconnected lambdas:
Each node sends a unique data pattern out each non-cross-connected lambda, following restoration of a fiber to UP or receiving light.
Each node also sends a unique data pattern out each cross-connected lambda, following restoration of a fiber to UP or receiving light prior to restoring existing cross-connects to service.
Adjacent nodes listen for the data patterns and confirm which lambda they received the pattern on via OSC control plane messages to the originating node.
Both adjacent nodes acknowledge data connectivity over the associated lambdas.
The NMS is notified of restored lambda-level connectivity between nodes.
The NMS checks the newly restored connectivity against last-known connectivity to detect and raise visibility of cabling changes/errors.

Therefore to support the example identified in FIG. 3:
Node 1 and Node 2 would originally automatically detect lambda level connectivity (A-B) between Node 1 and Node 2 via LMP, which would be sent to the NMS, which would automatically draw and list the lambda connectivity.
Following the cabling change from A-B to A-C, Node 1 and Node 2 would automatically detect new lambda-level connectivity (between A and C) via LMP, which would be sent to the NMS, and the NMS would automatically draw and list the new lambda-level connectivity.
Following the cabling change from A-C to A-D, Node 1 and Node 4 would automatically detect new lambda-level connectivity (between A and D) via LMP, which would be sent to the NMS, and the NMS would automatically draw and list the new lambda-level connectivity.

The NMS software part of the invention in this implementation performs the following functions:
Archives the original auto-discovered lambda connectivity (eg. A-B in FIGS. 1 and 3)
Archives subsequent auto-discovered lambda connectivity (eg. A-C in FIG. 1 and A-D in FIG. 3)
Correlates cabling changes with original connectivity (eg. A-C and A-D to A-B)
Detects and displays new connectivity and changes status of original to ‘miscabled’
Determines and displays impact to existing cross-connects and lightpaths
Offers a sequence of windows through a ‘Resolve Miscabling’ utility to ensure operator understands and acknowledges the impact of deleting the old connectivity, and accepting the new connectivity.

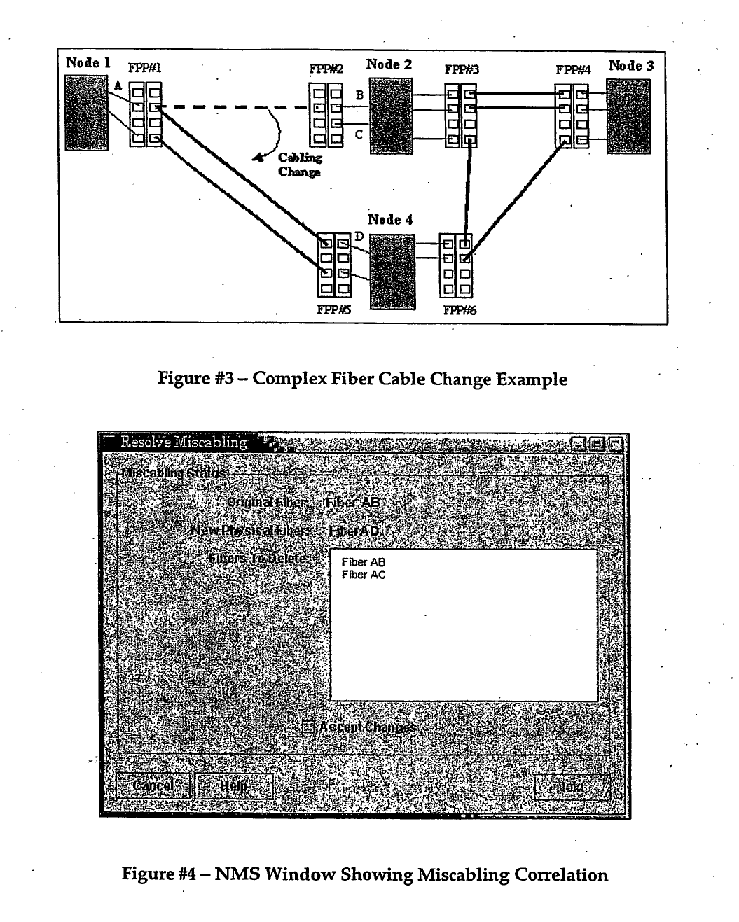

The ‘resolve cabling change’ utility offered as part of this example implementation utilizes NMS windows as shown in FIGS. 4, 5, and 6.

The ‘resolve cabling change’ utility in this example implementation is accessed after selecting a suspect fiber from a fiber list or through direct point-and-click selection from a network map on the NMS. The first NMS window shown in FIG. 4 shows all corresponding fiber or lambda-level connectivity, which has a common link endpoint to the originally selected fiber. For example in FIG. 4, the original fiber was automatically detected to exist between port A on Node 1, and Port B on Node 2. The current or most recently auto-discovered fiber is fiber A-D as shown in FIG. 3 and FIG. 4. FIG. 4 also shows an additional fiber A-C that had been detected (eg. a previous miscabling error by a field technician) prior to detecting the fiber A-D connectivity.

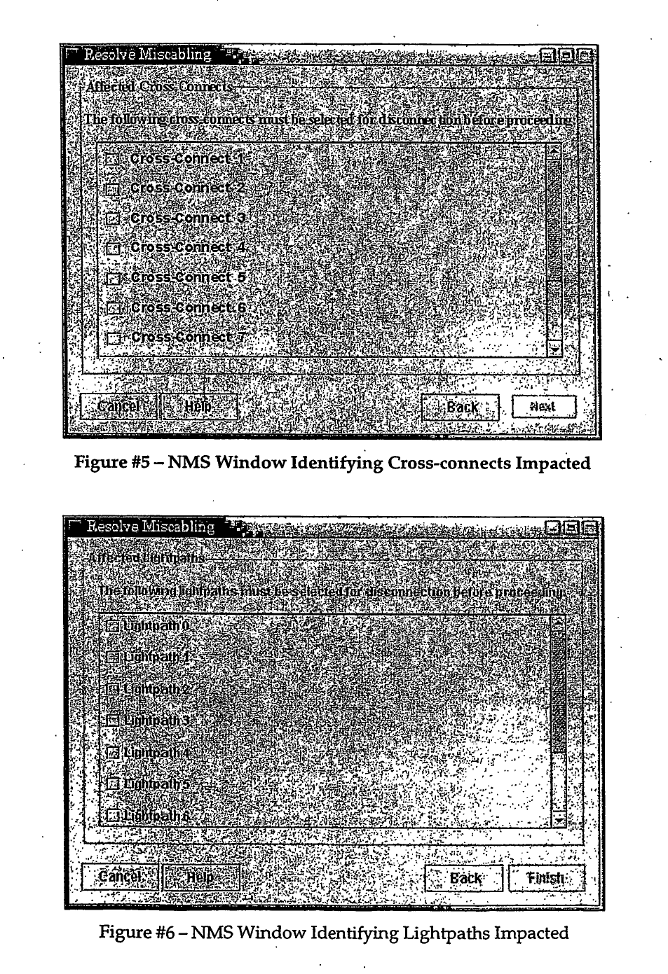

The second ‘resolve cabling change’ window shown in FIG. 5 shows all the corresponding cross-connects that would be affected if the AB and AC links are deleted. The operator is expected to acknowledge each affected cross-connect prior to proceeding to the next window. Upon completing the procession through the 3 windows these cross-connects will be automatically disconnected.

The third ‘resolve cabling change’ window of this example implementation, as shown in FIG. 6, shows all the corresponding lightpaths that would be affected if the AB or AC links are deleted. Only paths that traverse the original fiber, and have not been enabled for automatic reroute, or those paths which were unable to successfully reroute when the cabling change occurred (due to lack of available bandwidth, maximum hop count restrictions, etc.), would appear in the lightpath list to be disconnected. The operator is expected to acknowledge each affected lightpath prior to proceeding to the next window. Upon completing the procession through the three windows these lightpaths will be automatically disconnected.

To accept the cabling from A-D in this implementation (as shown in FIG. 3), the operator will have to acknowledge each of the following:
fibers to be deleted (in FIG. 4 that would be Fiber A-B, and Fiber A-C)
cross-connects affected (as shown in FIG. 5)
lightpaths affected (as shown in FIG. 6)

By the time the operator has acknowledged each of the listed impacts it should be very clear what the overall impact will be of the cabling change. By having to actively step through and acknowledge impact within each of the windows documented in FIGS. 4, 5, and 6, the operator will recognize the total service impact (if any) of accepting the cabling change.

If the cable change is accepted, then all the acknowledged fibers will be automatically deleted, the acknowledged cross-connects will be automatically disconnected, and the acknowledged lightpaths will be automatically disconnected when the operator hits the final ‘finish’ button as shown in FIG. 6.

If during the process of resolving the miscabling the operator realizes that this new connectivity is not correct and that the original fiber should not be deleted, (as determined by understanding the impact on fibers, cross-connects, and lightpaths,), the operation to accept the new fiber can be easily aborted through a cancel button offered in this implementation.

By the time the operator has acknowledged all of the listed impacts it should be very clear as to the overall impact of the cabling change. By having to actively step through and acknowledge impact within each of the windows documented in FIGS. 4, 5, and 6, the operator should recognize an erroneous cable change and cancel the ‘Resolve Miscabling’ operation.

If the cable change is recognized to be an error, the ‘Resolve Cabling’ operation would be canceled by the operator, technical staff will be dispatched to restore Fiber A-B, and no cross-connects or lightpaths will have been disconnected by the NMS. Fiber A-C and Fiber A-D would then be deleted by the operator, to correct the network representation on the NMS network map. In this example, service disruption will be minimized through proper impact awareness to the operator, and automatic detection of the cabling change in the first place.

Although particular embodiments of the invention have been described and illustrated it will be apparent to one skilled in the art that numerous changes can be made without departing from the basic concept. It is to be understood, however, that such changes will fall within the full scope of the invention as defined by the appended claims.

We claim:

1. A method of automatically detecting fiber cabling errors in an optical network comprising:
detecting current fiber connectivity between optical nodes in the network;
storing information regarding the current fiber link connectivity;
detecting any cabling changes; and
determining the impact of the cabling changes on service through the network.

2. The method as defined in claim 1 wherein the step of determining impact on services supports the step of directing operator resolution of errors caused by the cabling changes.

3. The method as defined in claim 2 implemented by an element management system (EMS) within a node.

4. The method as defined in claim 2 implemented within a network management system (NMS).

5. The method as defined in claim 2 implemented with an operations support system (OSS).

6. The method as defined in claim 2 implemented in a combination of EMS, NMS and OSS.

7. The method as defined in claim 1 wherein current fiber connectivity and any cabling changes are displayed on a graphical user interface (GUI).

8. The method as defined in claim 7 wherein the GUI displays a correlation between optical nodes in the network and fiber connectivity.

9. The method as defined in claim 7 wherein the GUI displays cross-connection impacted by a cabling change.

10. The method as defined in claim 7 wherein the GUI displays lightpaths impacted by a cabling change.

11. The method as defined in claim 7 wherein any cabling change must be approved by an operator before initiation of the change.

12. A system for automatically detecting fiber cabling errors in an optical network comprising.
an automatic optical link detection module to detect connectivity between optical nodes in the optical network;
an automatic cabling change detection module for storing initial fiber link connectivity and detecting any cabling changes; and
a cabling change impact and resolution module for determining impact of any cabling change.

13. The system as defined in claim 12 wherein the cabling change impact and resolution module supports operator directed resolution of cabling changes.

14. The system as defined in claim 12 having a graphical user interface (GUI) for displaying initial connectivity and cabling changes.

15. The system as defined in claim 12 wherein the modules are implemented in software at an element management system within the network.

16. The system as defined in claim 12 wherein the modules are implemented in software at a network management system.

17. The system as defined in claim 12 wherein the modules are implemented in software in an operator support system.

18. The system as defined in claim 12 wherein implementation of the modules is distributed through the network.

19. The system as defined in claim 14 wherein a link management protocol (LMP) is used to communicate data between modules.
